(19) United States
(12) Patent Application Publication
(10) Pub. No.: US 2021/0201833 A1
(43) Pub. Date: Jul. 1, 2021

(54) DISPLAY DRIVING METHOD, DISPLAY DRIVE DEVICE, DISPLAY DEVICE, AND STORAGE MEDIUM

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Lixin ZHU, Beijing (CN); Chunyang NIE, Beijing (CN); Bingbing YAN, Beijing (CN)

(21) Appl. No.: 17/057,530

(22) PCT Filed: Mar. 6, 2020
(86) PCT No.: PCT/CN2020/078209

§ 371 Date: Nov. 20, 2020

(30) Foreign Application Priority Data
Mar. 29, 2019 (CN) 201910248150.7

(51) Int. Cl. G09G 3/34; G09G 3/36

(52) U.S. Cl. CPC G09G 3/3406; G09G 3/3648; G09G 2320/0233; G09G 2320/064; G09G 2310/0251; G09G 2310/08

(57) ABSTRACT

A display drive method of a display device, a display drive device, a display device, and a storage medium are provided. The display device includes a display panel and a backlight module configured to provide backlight to the display panel, the display drive method includes: determining a first pixel unit area corresponding to a light-emitting area of the backlight module and a second pixel unit area corresponding to a non-light-emitting area of the backlight module in the display panel; for the first pixel unit area and the second pixel unit area, respectively generating a first clock signal and a second clock signal.

The present application claims priority of Chinese Patent Application No. 201910248150.7, filed on Mar. 29, 2019, and the entire content disclosed by the Chinese patent application is incorporated herein by reference as part of the present application for all purposes under the U.S. law.

### TECHNICAL FIELD

The embodiments of the present disclosure relate to a display drive method of a display device, a drive device of a display device, a display device, and a storage medium.

### BACKGROUND

Currently, a liquid crystal display device generally includes a liquid crystal display panel and a backlight module. For example, a pulse width modulation technology can be used to control the backlight module to provide the desired backlight brightness for the liquid crystal display panel. In the liquid crystal display panel, a switching transistor in a pixel unit is turned on according to a gate drive signal, a data drive signal is provided to the pixel unit through the turned-on switching transistor to charge the pixel unit, and liquid crystal molecules in the pixel unit are deflected correspondingly according to the written data signal, thereby controlling the transmittance of light emitted by the backlight module to achieve image display.

### SUMMARY

At least one embodiment of the present disclosure provides a display drive method of a display device, wherein the display device comprises a display panel and a backlight module configured to provide backlight to the display panel, the display drive method comprises: determining a first pixel unit area corresponding to a light-emitting area of the backlight module and a second pixel unit area corresponding to a non-light-emitting area of the backlight module in the display panel; and for the first pixel unit area and the second pixel unit area, respectively generating a first clock signal and a second clock signal; the first clock signal is used for generating gate drive signals for pixel units in the first pixel unit area, and the second clock signal is used for generating gate drive signals for pixel units in the second pixel unit area; a phase of the first clock signal lags behind a phase of the second clock signal.

For example, in the display drive method provided by some embodiments of the present disclosure, determining the first pixel unit area corresponding to the light-emitting area of the backlight module and the second pixel unit area corresponding to the non-light-emitting area of the backlight module in the display panel, comprises: acquiring parameters of a backlight drive signal for driving the backlight module, and determining the light-emitting area and the non-light-emitting area of the backlight module according to the parameters of the backlight drive signal; the parameters of the backlight drive signal comprise an active level period and an inactive level period of the backlight drive signal, an area driven during the active level period of the backlight drive signal corresponds to the light-emitting area of the backlight module, and an area driven during the inactive level period of the backlight drive signal corresponds to the non-light-emitting area of the backlight module.

For example, in the display drive method provided by some embodiments of the present disclosure, for the first pixel unit area and the second pixel unit area, respectively generating the first clock signal and the second clock signal, comprises: generating an initial clock signal; for the pixel units in the first pixel unit area, taking the initial clock signal as the first clock signal; and for the pixel units in the second pixel unit area, advancing a phase of the initial clock signal to generate the second clock signal.

For example, in the display drive method provided by some embodiments of the present disclosure, for the first pixel unit area and the second pixel unit area, respectively generating the first clock signal and the second clock signal, comprises: generating an initial clock signal; for the pixel units in the first pixel unit area, delaying a phase of the initial clock signal to generate the first clock signal; and for the pixel units in the second pixel unit area, taking the initial clock signal as the second clock signal.

For example, in the display drive method provided by some embodiments of the present disclosure, for the first pixel unit area and the second pixel unit area, respectively generating the first clock signal and the second clock signal, comprises: generating an initial clock signal; for the pixel units in the first pixel unit area, adjusting a phase of the initial clock signal to generate the first clock signal; and for the pixel units in the second pixel unit area, adjusting the phase of the initial clock signal to generate the second clock signal.

For example, in the display drive method provided by some embodiments of the present disclosure, determining the first pixel unit area corresponding to the light-emitting area of the backlight module and the second pixel unit area corresponding to the non-light-emitting area of the backlight module in the display panel according to the backlight drive signal for driving the backlight module, comprises: acquiring a frequency and a duty ratio of the backlight drive signal; calculating an active level period and an inactive level period in a single cycle of the backlight drive signal based on the frequency and the duty ratio; determining a charging time period for one row of pixel units of the display panel; based on the active level period and the charging time period, determining the first pixel unit area in the display panel corresponding to the active level period; and based on the inactive level period and the charging time period, determining the second pixel unit area in the display panel corresponding to the inactive level period.

For example, in the display drive method provided by some embodiments of the present disclosure, determining the charging time period for one row of pixel units of the display panel, comprises: acquiring resolution and a scanning frequency of the display panel; and calculating the charging time period according to the resolution and the scanning frequency.

For example, in the display drive method provided by some embodiments of the present disclosure, the backlight drive signal is a pulse width modulation signal.

At least one embodiment of the present disclosure provides a display drive device of a display device, comprising: a processor; a memory; and one or more computer program modules, wherein the one or more computer program modules are stored in the memory and are configured to be executed by the processor, and the one or more computer program modules comprise instructions for implementing the display drive method provided by any embodiment of the present disclosure.

At least one embodiment of the present disclosure provides a display drive device of a display drive device of a display device, the display device comprises a display panel and a backlight module configured to provide backlight to the display panel, and the display drive device comprises: a determination unit, configured to determine a first pixel unit area corresponding to a light-emitting area of the backlight module and a second pixel unit area corresponding to a non-light-emitting area of the backlight module in the display panel; and a generation unit, configured to respectively generate a first clock signal and a second clock signal for the first pixel unit area and the second pixel unit area, the first clock signal is used for generating gate drive signals for pixel units in the first pixel unit area, and the second clock signal is used for generating gate drive signals for pixel units in the second pixel unit area; a phase of the first clock signal lags behind a phase of the second clock signal.

For example, in the display drive device provided by some embodiments of the present disclosure, the determination unit is further configured to: acquire parameters of a backlight drive signal for driving the backlight module, and determine the light-emitting area and the non-light-emitting area of the backlight module according to the parameters of the backlight drive signal; the parameters of the backlight drive signal comprise an active level period and an inactive level period of the backlight drive signal, an area driven during the active level period of the backlight drive signal corresponds to the light-emitting area of the backlight module, and an area driven during the inactive level period of the backlight drive signal corresponds to the non-light-emitting area of the backlight module.

For example, in the display drive device provided by some embodiments of the present disclosure, the generation unit is further configured to: generate an initial clock signal; for the pixel units in the first pixel unit area, take the initial clock signal as the first clock signal; and for the pixel units in the second pixel unit area, advance a phase of the initial clock signal to generate the second clock signal.

For example, in the display drive device provided by some embodiments of the present disclosure, the generation unit is further configured to: generate an initial clock signal; for the pixel units in the first pixel unit area, delay a phase of the initial clock signal to generate the first clock signal; and for the pixel units in the second pixel unit area, take the initial clock signal as the second clock signal.

For example, in the display drive device provided by some embodiments of the present disclosure, the generation unit is further configured to: generate an initial clock signal; for the pixel units in the first pixel unit area, delay a phase of the initial clock signal to generate the first clock signal; and for the pixel units in the second pixel unit area, advance the phase of the initial clock signal to generate the second clock signal.

For example, in the display drive device provided by some embodiments of the present disclosure, the determination unit is further configured to: acquire a frequency and a duty ratio of the backlight drive signal; calculate an active level period and an inactive level period in a single cycle of the backlight drive signal based on the frequency and the duty ratio; determine a charging time period for one row of pixel units of the display panel; based on the active level period and the charging time period, determine the first pixel unit area in the display panel corresponding to the active level period; and based on the inactive level period and the charging time period, determine the second pixel unit area in the display panel corresponding to the inactive level period.

For example, in the display drive device provided by some embodiments of the present disclosure, the determination unit is further configured to: acquire resolution and a scanning frequency of the display panel; and calculate the charging time period according to the resolution and the scanning frequency.

For example, in the display drive device provided by some embodiments of the present disclosure, the backlight drive signal of the backlight module is a pulse width modulation signal.

At least one embodiment of the present disclosure provides a display device, comprising: a display panel, a backlight module, and the display drive device provided by any embodiment of the present disclosure; and the backlight module is configured to provide the backlight to the display panel.

For example, in the display device provided by some embodiments of the present disclosure, the display panel comprises a display substrate and a gate drive circuit prepared on the display substrate; and the gate drive circuit is configured to output a first gate drive signal to the first pixel unit area under control of the first clock signal, and to output a second gate drive signal to the second pixel unit area under control of the second clock signal.

At least one embodiment of the present disclosure provides a storage medium non-temporarily storing computer-readable instructions, in a case where the computer-readable instructions are executed by a computer, the display drive method provided by any embodiment of the present disclosure; can be executed.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative to the disclosure.

FIG. 1A shows a schematic diagram of a charging time period for a pixel unit and an enable time period of a gate drive signal;

FIG. 1B is a schematic diagram of a display panel displaying water ripple phenomenon;

FIG. 1C is a schematic diagram of a display drive method of a display device according to at least one embodiment of the present disclosure;

FIG. 2 shows a schematic flowchart of a display drive method of a display device according to at least one embodiment of the present disclosure;

FIG. 3 shows a flowchart of a process for determining a first pixel unit area and a second pixel unit area according to at least one embodiment of the present disclosure;

FIG. 4 shows a flowchart of a process for determining the charging time period for one row of pixel units of a display panel according to at least one embodiment of the present disclosure;

FIG. 5 shows a flowchart of an example of a process for generating a first clock signal and a second clock signal according to at least one embodiment of the present disclosure;

FIG. 6 shows a flowchart of another example of a process for generating a first clock signal and a second clock signal according to at least one embodiment of the present disclosure;

FIG. 7 shows a flowchart of still another example of a process for generating a first clock signal and a second clock signal according to at least one embodiment of the present disclosure;

FIG. 8A shows a schematic diagram of a display drive device according to at least one embodiment of the present disclosure;

FIG. 8B shows a schematic diagram of another display drive device according to at least one embodiment of the present disclosure;

FIG. 9A shows a schematic diagram of a display device according to at least one embodiment of the present disclosure;

FIG. 9B shows a system schematic diagram of another display device provided by at least one embodiment of the present disclosure; and

FIG. 10 shows a schematic diagram of a storage medium according to at least one embodiment of the present disclosure.

### DETAILED DESCRIPTION

In order to make objects, technical solutions and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments of the present disclosure, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The present disclosure is described below with reference to some specific embodiments. In order to enable the following description of the embodiments of the present disclosure clear and concise, the present disclosure omits detailed description of known functions and known components. In the case where any component in the embodiments of the present disclosure appears in more than one drawing, the component is denoted by the same or similar reference numerals in the drawings.

A liquid crystal display panel includes a liquid crystal panel and a backlight module. Generally, the liquid crystal panel includes an array substrate and an opposite substrate (such as a color filter substrate) that are arranged opposite to each other to form a liquid crystal cell, and the liquid crystal cell is filled with a liquid crystal layer between the array substrate and the opposite substrate; a first polarizer is arranged on the array substrate, a second polarizer is arranged on the opposite substrate, and a polarization direction of the first polarizer and a polarization direction of the second polarizer are perpendicular to each other. The backlight module is arranged on a non-display side of the liquid crystal panel and is used to provide a flat light source for the display of the liquid crystal panel. Under an action of a drive electric field formed between a pixel electrode of a sub-pixel provided on the array substrate and a common electrode provided on the array substrate or the common electrode provided on the opposite substrate, liquid crystal molecules in the liquid crystal layer are twisted. After the liquid crystal molecules are twisted by a predetermined angle, the polarization direction of the light passing through the liquid crystal layer can be controlled, and the light transmittance can be controlled under the cooperation of the first polarizer and the second polarizer, so as to achieve gray scale display.

For example, the backlight module may be a direct-type backlight module or a side-in-type backlight module. For example, a direct-type backlight module or a side-in-type backlight module may include a plurality of point light sources (such as light-emitting diodes (LED)) arranged in parallel and a diffuser plate. The light emitted by these point light sources is homogenized by the diffuser plate, and then is incident on the liquid crystal panel for display. For example, the side-in-type backlight module can use the global dimming technology to achieve the overall brightness adjustment of the backlight module, and the direct-type backlight module can use a row-by-row lighting method to achieve the brightness adjustment of the backlight module. For example, in a case where the local dimming technology is used for scanning by area, respective backlight sub-areas of the backlight module and display panels corresponding to the respective backlight sub-areas are separately controlled. For example, the respective backlight sub-areas adopt different PWMs to achieve progressive scan driving, and the display panels corresponding to the respective backlight sub-areas use different gate drive signals to achieve the progressive scan driving, so as to achieve the light emission of the display panel.

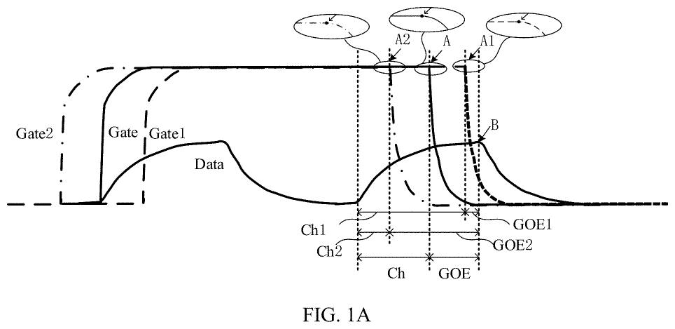

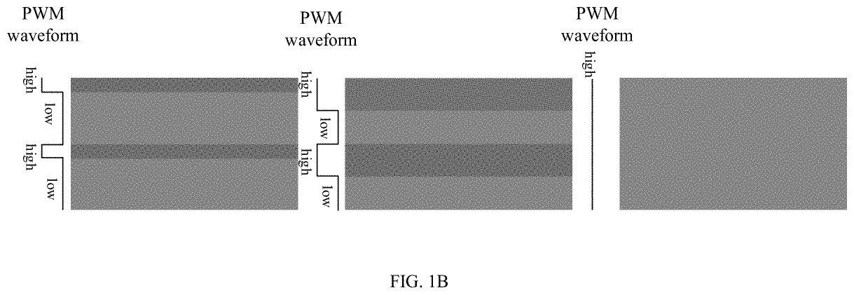

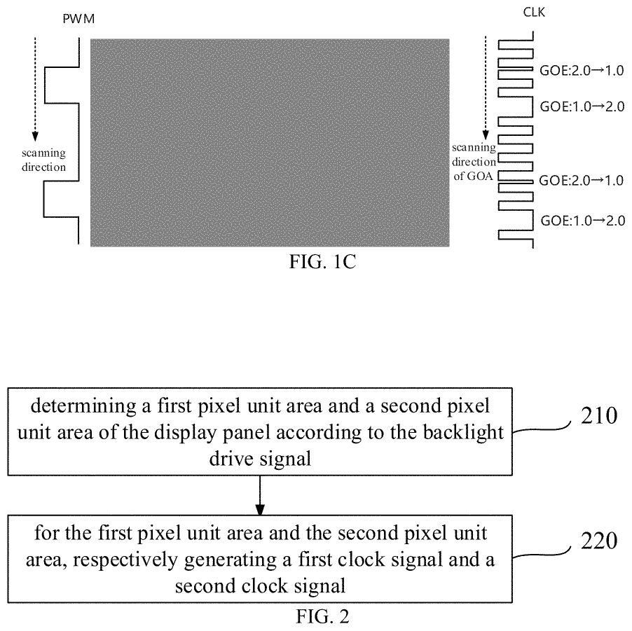

As mentioned above, the backlight module is driven by the pulse width modulation signal. For example, in the backlight module, a part corresponding to the high level of the pulse width modulation signal is lit, and a part corresponding to the low level signal of the pulse width modulation signal is not lit. Under the illumination of the light emitted by the backlight module, the leakage current of the switching transistor in the pixel unit of the display panel increases, resulting in insufficient charging of the pixel unit. Therefore, a dark area corresponding to the lighted part of the backlight module and a bright area corresponding to the un-lighted part of the backlight module are displayed on the display panel, thereby forming a water ripple as shown in FIG. 1B on the display panel, and thus affecting the display quality of the display device.

In a case of not changing the charging current, the charge amount of the pixel unit is positively correlated with the charging time period, and is negatively correlated with the leakage current of the transistor in the pixel unit.

For example, as shown in FIG. 1A, the phase difference between the inflection point (A, A1, and A2) of the gate drive signal (controlling the turn-on and turn-off of the switching transistor of the pixel unit) and the inflection point (B) of the data drive signal (written by the turned-on switching transistor in the pixel unit to charge the pixel unit) is the enable time period of the gate drive signal (GOE, GOE1, and GOE2). For example, after the resolution and the refresh frequency of the display panel are determined, a total charging time period, that is, the sum of the enable time period GOE and an actual charging time period, for each row of pixel units can be determined by methods in the field, so that the sum of the enable time period GOE and the actual charging time period is also a fixed value based on the determined resolution and scanning frequency when the display panel leaves the factory. Therefore, in a case where only the phase of the gate drive signal is changed, the sum of the charging time period of the pixel unit and the enable time period of the gate drive signal remains unchanged. Therefore, the actual charging time period of the pixel unit can be determined by the enable time period of the gate drive signal. Thus, in a case where the phase of the gate drive signal is delayed (for example, being delayed from a curve Gate to a curve Gate1 as shown in FIG. 1A), the enable time period of the gate drive signal decreases (that is, changing from the enable time period GOE to enable time period GOE1), the corresponding charging time period becomes longer (i.e., the charging time period Ch becomes the charging time period Ch1). In the same way, in a case where the phase of the gate drive signal is advanced (that is, being advanced from the curve Gate to a curve Gate2), the enable time period of the gate drive signal increases (that is, changing from the enable time period GOE to the enable time period GOE2), the corresponding charging time period is shortened (i.e., the charging time period Ch becomes the charging time period Ch2). Therefore, the charging time period of the pixel unit is related to the enable time period of the gate drive signal, that is, is related to the phase of the gate drive signal provided to the pixel unit. In addition, because the gate drive circuit in the display panel outputs the clock signal as the gate drive signal, the phase of the output clock signal is the same as the phase of the gate drive signal, so that the charging time period of the pixel unit is related to the phase of the clock signal.

At least one embodiment of the present disclosure provides a display drive method of a display device. The display device includes a display panel and a backlight module configured to provide backlight to the display panel. The display drive method comprises: determining a first pixel unit area corresponding to a light-emitting area of the backlight module and a second pixel unit area corresponding to a non-light-emitting area of the backlight module in the display panel; and for the first pixel unit area and the second pixel unit area, respectively generating a first clock signal and a second clock signal, the first clock signal being used for generating gate drive signals for pixel units in the first pixel unit area, and the second clock signal being used for generating gate drive signals for pixel units in the second pixel unit area. A phase of the first clock signal lags behind a phase of the second clock signal.

At least one embodiment of the present disclosure also provides a display drive device, a display device, and a storage medium corresponding to the above-mentioned display drive method.

The display drive method of the display device provided by the embodiment of the present disclosure dynamically adjusts the charging time period of the pixel unit in the bright area and/or the dark area by dynamically adjusting the phase of the clock signal, thereby solving the problem of insufficient charging caused by the increase of the leakage current of the transistor in the pixel unit. The display drive method can enable the brightness of the display panel uniform, avoid the bright area and the dark area from appearing on the display panel, thereby improving the display quality of the display device.

The method of the embodiments of the present disclosure will be described in detail below with reference to the accompanying drawings.

FIG. 2 shows a schematic flowchart of a display drive method for controlling a display device according to an embodiment of the present disclosure. For example, the display device includes a backlight module and a display panel, the backlight module is disposed on a non-display side of the display panel and is driven by a backlight drive signal to provide a flat light source for the display of the display panel.

For example, the backlight module includes one or more light-emitting elements, such as light-emitting diodes, to emit corresponding light under the control of the backlight drive signal. For example, the display device may be a liquid crystal display (Liquid Crystal Display, LCD) or an electronic paper display device, and the embodiments of the present disclosure are not limited thereto. Correspondingly, the display panel of the display device may be a liquid crystal display panel or an electronic paper display panel, etc., for example, the liquid crystal display panel may be a vertical electric field type, a horizontal electric field type, etc. The embodiments of the present disclosure are not limited to the specific structure and type of the display panel (for example, the vertical electric field type or the horizontal electric field type liquid crystal display panel).

For example, the LCD display device may also include a pixel array, a data decoding circuit, a timing controller, a gate driver, a data driver, a storage device (such as flash memory, etc.), and the like. The pixel array includes a plurality of pixel units arranged in an array. These pixel units are arranged in plural rows and plural columns. The amount of rows and the amount of columns are related to the resolution of the display device. Each pixel unit includes a pixel electrode, and each pixel unit may also include a common electrode, or a plurality of pixel units share the same common electrode. The data decoding circuit receives a display input signal and decodes the display input signal to obtain a display data signal; the timing controller outputs timing signals to control the gate driver, data driver, and the like to synchronously operate, can perform gamma correction on the display data signal, and input the processed display data signal to the data driver to perform a display operation. These components can be implemented in a conventional manner, the embodiments of the present disclosure are not limited in this aspect, and redundant parts will not be repeated here.

The display drive method provided by some embodiments of the present disclosure can be implemented at least in part by software, hardware, firmware, or any combination thereof, and can dynamically adjust the phase of the clock signal to dynamically adjust the charging time period of the pixel unit in the display area and/or the non-display area, thereby solving the problem of insufficient charging caused by the increase of the leakage current of the transistor in the pixel unit, avoiding the generation of water ripples on the display panel during the display process, and avoiding the bright area and the dark area from appearing on the display panel, and thus improving the display quality of the display device.

Hereinafter, the display drive method of the display device provided by some embodiments of the present disclosure will be described with reference to FIG. 2. As shown in FIG. 2, the display drive method includes steps 210 to 220. The steps 210 to 220 of the display drive method and their respective exemplary implementation manners are respectively described below.

Step 210: determining a first pixel unit area and a second pixel unit area of the display panel.

Step 220: for the first pixel unit area and the second pixel unit area, respectively generating a first clock signal and a second clock signal.

For the step 210, for example, the first pixel unit area of the display panel corresponds to a light-emitting area of the backlight module. Because the backlight module emits light in response to an active level of the backlight drive signal, the first pixel unit area of the display panel corresponding to the light-emitting area of the backlight module can also be understood as the first pixel unit area of the display panel corresponding to an area driven during the active level period of the backlight drive signal. For example, the second pixel unit area of the display panel corresponds to a non-light emitting area of the backlight module, that is, corresponds to an area driven during an inactive level period of the backlight drive signal.

For example, this step further includes: acquiring parameters of a backlight drive signal for driving the backlight module, and determining the light-emitting area and the non-light-emitting area of the backlight module according to the parameters of the backlight drive signal. For example, the parameters of the backlight drive signal comprise an active level period and an inactive level period of the backlight drive signal, an area driven during the active level period of the backlight drive signal corresponds to the light-emitting area of the backlight module; and an area driven during the inactive level period of the backlight drive signal corresponds to the non-light-emitting area of the backlight module.

For example, in a case where the backlight module emits light in response to a high level of the backlight drive signal, the active level is a high level, and the inactive level is a low level; in a case where the backlight module emits light in response to a low level of the backlight drive signal, the active level is a low level, and the inactive level is a high level, and the embodiment of the present disclosure are not limited thereto. A case where the active level is a high level, the inactive level is a low level, the active level period is a high level period, and the inactive level period is a low level period is taken as an example for description, however, the embodiments of the present disclosure are not limited in this aspect.

For example, a determination unit may be provided, and the first pixel unit area and the second pixel unit area of the display panel may be determined by the determination unit; for example, the determination unit can also be implemented through a central processing unit (CPU), a graphics processing unit (GPU), a tensor processor (TPU), a field programmable gate array (FPGA), or other forms of processing units with data processing capabilities and/or instruction execution capabilities and corresponding computer instructions. For example, the processing unit may be a general-purpose processor or a special-purpose processor, and may be a processor based on the X86 or ARM architecture.

For the step 220, because the leakage current of the switching transistor in the pixel unit in the first pixel unit area, corresponding to the light-emitting area, of the display panel is increased under the illumination of the light emitted from the light-emitting area of the backlight module, resulting in insufficient charging of the pixel unit in the first pixel unit area, thereby forming a dark area corresponding to the first pixel unit area and a bright area corresponding to the second pixel unit area on the display panel, and thus affecting the display quality of the display panel. Therefore, for the first pixel unit area and the second pixel unit area, in this step, the gate drive signals (for example, the first gate drive signal and the second gate drive signal) generated by the control signals (for example, the first clock signal and the second clock signal) with different phases are used to drive the first pixel unit area and the second pixel unit area respectively to solve the above-mentioned insufficient charging problem.

For example, in the embodiments of the present disclosure, the phase of the first clock signal lags behind the phase of the second clock signal, that is, the phase of the first gate drive signal (for example, Gate1 as shown in FIG. 1A) corresponding to the first clock signal lags behind the phase of the second gate drive signal (for example, Gate2 as shown in FIG. 1A) corresponding to the second clock signal, and therefore, as shown in FIG. 1A, the charging time period of the pixel unit in the first pixel unit area driven by the first gate drive signal can be prolonged, thereby solving the problem of insufficient charging of the pixel unit in the first pixel unit area, avoiding the bright area and the dark area from appearing on the display panel, and improving the display quality of the display device.

For example, a display image on the display panel driven by this display drive method is shown in FIG. 1C, as can be seen from FIG. 1C, the display drive method of the embodiment of the present disclosure solves the problem of appearing the bright area and the dark area on the display panel caused by insufficient charging of the pixel unit, thereby avoiding the appearance of water ripples on the display panel, and improving the display quality of the display panel.

For example, a generation unit may be provided, and the first clock signal and the second clock signal may be respectively generated for the first pixel unit area and the second pixel unit area through the generation unit; for example, the generation unit can also be implemented through a central processing unit (CPU), a graphics processing unit (GPU), a tensor processor (TPU), a field programmable gate array (FPGA), or other forms of processing units with data processing capabilities and/or instruction execution capabilities and corresponding computer instructions.

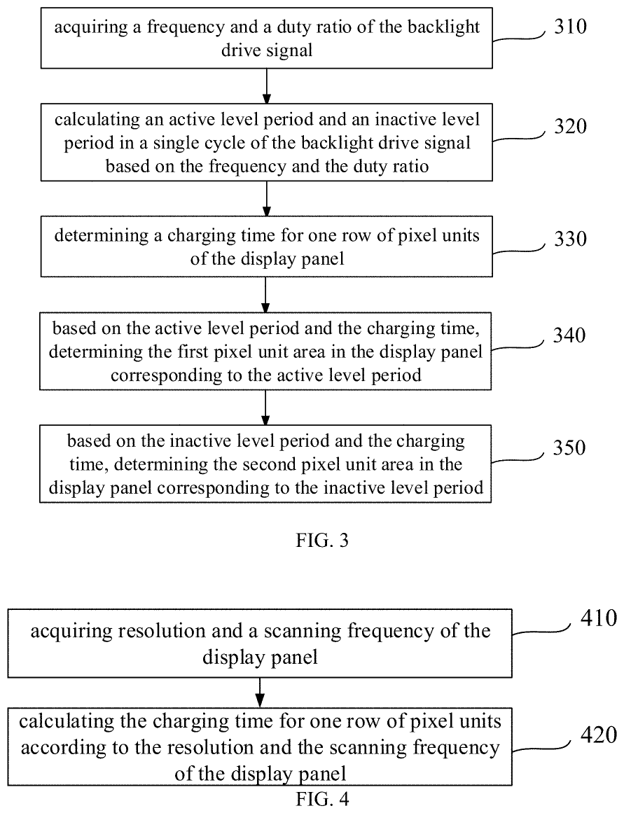

FIG. 3 shows a flowchart of a process for determining a first pixel unit area and a second pixel unit area according to an embodiment of the present disclosure. That is, FIG. 3 is a flowchart of an example of step 210 as shown in FIG. 2. For example, in the example shown in FIG. 3, the method for determining the first pixel unit area and the second pixel unit area includes step 310 to step 350. The method for determining the first pixel unit area and the second pixel unit area in the embodiment of the present disclosure will be described in detail below with reference to FIG. 3.

Step 310: acquiring a frequency and a duty ratio of the backlight drive signal.

Step 320: calculating an active level period and an inactive level period in a single cycle of the backlight drive signal based on the frequency and the duty ratio.

Step 330: determining a charging time period for one row of pixel units of the display panel.

Step 340: based on the active level period and the charging time period, determining the first pixel unit area in the display panel corresponding to the active level period.

Step 350: based on the inactive level period and the charging time period, determining the second pixel unit area in the display panel corresponding to the inactive level period.

For step 310, for example, the frequency F and the duty ratio P of the backlight drive signal may be obtained through other processing units, such as the aforementioned GPU, CPU, or FPGA. For example, the frequency and duty ratio of the backlight drive signal are fed back to a control device (for example, a timing controller) of the display panel, and the related operations from step 320 to step 350 are performed in the control device of the display panel.

For step 320, for example, firstly, a period T of the backlight drive signal is obtained based on the frequency F of the backlight drive signal, and then, based on the obtained period T and the duty ratio P of the backlight drive signal, the high level period Tg and the low level period Td in a single cycle of the backlight drive signal are calculated. In the embodiment of the present disclosure, based on the obtained frequency F and the duty ratio P, the high level period Tg in a single cycle of the backlight drive signal can be calculated according to formula (1), and the formula (1) is as follows:

$${T}_{g} = T * P = \frac{1}{F} * P , wherein , T = \frac{1}{F} \qquad formula ( 1 )$$

Similarly, in the embodiments of the present disclosure, the low level period Td in a single cycle of the backlight drive signal can be calculated according to formula (2), and the formula (2) is as follows:

$${T}_{d} = \frac{1}{F} * ( 1 - P ) \qquad formula ( 2 )$$

For step 330, for example, the charging time period for one row of pixel units of the display panel is determined according to the resolution of the display panel and the scanning frequency of the display panel.

FIG. 4 shows a flowchart of a process for determining the charging time period for one row of pixel units of the display panel according to an embodiment of the present disclosure. That is, FIG. 4 is a flowchart of an example of step 330 as shown in FIG. 3. As shown in FIG. 4, the method for determining the charging time period includes step 410 and step 420. The method for determining the charging time period provided by the embodiment of the present disclosure will be described in detail below with reference to FIG. 4.

Step 410: acquiring resolution and a scanning frequency of the display panel.

Step 420: calculating the charging time period for one row of pixel units according to the resolution and the scanning frequency of the display panel.

As shown in FIG. 4, for step 410, for example, the obtained resolution of the display panel is C×R (where C is the amount of columns, R is the amount of rows, and C and R are both positive integers) and the obtained scanning frequency is f.

For step 420, the charging time period Tc for one row of pixel units is calculated according to the resolution C×R and the scanning frequency f of the display panel. In the embodiment of the present disclosure, according to the acquired resolution C×R and the obtained scanning frequency f of the display panel, the charging time period Tc for one row of pixel units of the display panel can be calculated by formula (3), and formula (3) is as follows:

$${T}_{C} = \frac{1}{{f}^{*} R} \qquad formula ( 3 )$$

For step 340, based on the high level period of the backlight drive signal and the charging time period, the first pixel unit area in the display panel corresponding to the light-emitting area of the backlight module is determined. Because the light-emitting area of the backlight module is the area of the backlight module corresponding to the high level period of the backlight drive signal, in the embodiment of the present disclosure, based on the high level period of the backlight drive signal and charging time period, the first pixel unit area corresponding to the light-emitting area of the backlight module (i.e., the high level period of the backlight drive signal) in the display panel can be determined. Correspondingly, in the embodiment of the present disclosure, based on the high level period Tg in a single cycle of the backlight drive signal and the charging time period Tc, the amount of rows N of the pixel units in the pixel unit area corresponding to a single high level period Tg can be determined according to formula (4), and the formula (4) is as follows:

$$N = \frac{{T}_{g}}{{T}_{c}} \qquad formula ( 4 )$$

Further, all pixel unit areas corresponding to the high level periods of the backlight drive signal on the entire display panel can be determined according to the frequency F of the backlight drive signal. These pixel unit areas constitute the first pixel unit area.

For step 350, based on the low level period and the charging time period, the second pixel unit area corresponding to the non-light-emitting area of the backlight module (that is, the low level period of the backlight drive signal) in the display panel is determined. In the embodiment of the present disclosure, based on the low level period Td in a single cycle of the backlight drive signal and the charging time period Tc, the amount of rows M (M is a positive integer) of pixel units included in the pixel unit area corresponding to a single low level period Td in the display panel can be determined according to formula (5), and the formula (5) is as follows:

$$M = \frac{{T}_{d}}{{T}_{c}} \qquad formula ( 5 )$$

Further, all pixel unit areas corresponding to the low level periods of the backlight drive signal on the entire display panel can be determined according to the frequency F of the backlight drive signal. These pixel unit areas constitute the second pixel unit area.

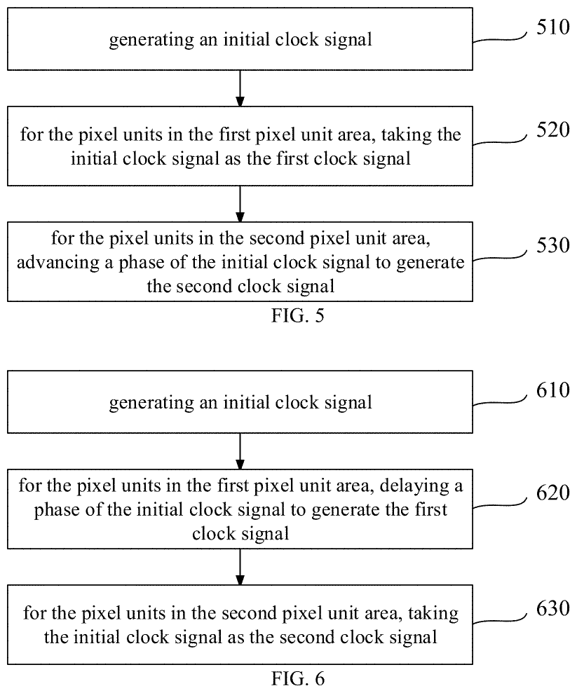

For step 220, for the first pixel unit area and the second pixel unit area, a first clock signal and a second clock signal are respectively generated. In the embodiment of the present disclosure, the first clock signal is generated for the first pixel unit area, and the second clock signal is generated for the second pixel unit area. The first clock signal is used for generating gate drive signals (hereinafter referred to as first gate drive signals) for pixel units in the first pixel unit area. The second clock signal is used for generating gate drive signals (hereinafter referred to as second gate drive signals) for pixel units in the second pixel unit area. As mentioned above, because the backlight module corresponding to the first pixel unit area generates backlight, and the backlight causes the leakage current of the transistor in the pixel unit to increase, therefore, in order to avoid the problem of insufficient charging of the pixel unit due to the increased leakage current, the charging time period of the pixel unit in the first pixel unit area should be longer than the charging time period of the pixel unit in the second pixel unit area, that is, the expected enable time period GOE1 of the first gate drive signal is less than the expected enable time period GOE2 of the second gate drive signal, that is, the first gate drive signal lags behind the second gate drive signal. Therefore, the phase of the first clock signal should lag behind the phase of the second clock signal. Step 220 will be described in detail below with reference to FIGS. 5 to 7.

FIG. 5 shows a flowchart of a process for generating a first clock signal and a second clock signal according to an embodiment of the present disclosure. That is, FIG. 5 is a flowchart of an example of step 220 as shown in FIG. 2. As shown in FIG. 5, the method for determining the first clock signal and the second clock signal includes step 510 to step 530. The method for determining the first clock signal and the second clock signal provided by the embodiment of the present disclosure will be described in detail below in conjunction with FIG. 5.

Step S510: generating an initial clock signal.

Step S520: for the pixel units in the first pixel unit area, taking the initial clock signal as the first clock signal.

Step S530: for the pixel units in the second pixel unit area, advancing a phase of the initial clock signal to generate the second clock signal.

As shown in FIG. 5, for step 510, for example, an initial clock signal is generated according to the first gate drive signal. For example, in some embodiments of the present disclosure, the initial clock signal may be generated based on the expected enable time period of the first gate drive signal. The expected enable time period of the first gate drive signal can be used to determine the charging time period of the pixel unit in the first pixel unit area. For example, as shown in FIG. 1A, because the sum (Ch+GOE) of the expected enable time period GOE and the charging time period of the pixel unit is fixed, the charging time period Ch1 of the pixel unit in the first pixel unit area is equal to the value that the sum (Ch+GOE) minus the expected enable time period GOE1 of the first gate drive signal.

For example, as shown in FIG. 1A, the expected enable time period of the first gate drive signal determines the inflection point A1 of the first gate drive signal, so that the first gate drive signal can be determined, and the initial clock signal can be determined based on the first gate drive signal. For example, the initial clock signal may be generated in the timing controller of the display panel, and the embodiments of the present disclosure are not limited to this case.

For step 520, because the initial clock signal is determined based on the expected enable time period of the first gate drive signal (for driving the first pixel unit area), and therefore, for the pixel units in the first pixel unit area, the initial clock signal is used as the first clock signal.

For step 530, for the pixel units in the second pixel unit area, the phase of the initial clock signal is advanced to generate the second clock signal.

For example, in this embodiment, the phase difference of the second clock signal relative to the first clock signal can be determined based on the expected enable time period of the first gate drive signal and the expected enable time period of the second gate drive signal, for example, the phase difference of the second clock signal with respect to the first clock signal is determined according to the difference between the expected enable time period of the first gate drive signal and the expected enable time period of the second gate drive signal. For example, the expected enable time period of the second gate drive signal can be used to determine the charging time period of the pixel unit in the second pixel unit area. Then, based on the determined phase difference, the initial clock signal is advanced by a corresponding phase to generate the second clock signal. For example, the expected enable time period of the first gate drive signal is 1.0 μs, and the expected enable time period of the second gate drive signal is 2.0 μs. For example, the initial clock signal is advanced by 1.0 μs to generate the second clock signal.

Therefore, in the embodiment of the present disclosure, because the first pixel unit area corresponding to the high level period can extend the charging time period, the problem of insufficient charging caused by the increase of the leakage current of the transistor in the pixel unit in the first pixel unit area can be avoided, thereby avoiding the bright area and the dark area from appearing on the display panel, and thus improving the display quality of the display device.

FIG. 6 shows a flowchart of a process for generating a first clock signal and a second clock signal according to another embodiment of the present disclosure. That is, FIG. 6 is a flowchart of another example of step 220 as shown in FIG. 2. As shown in FIG. 6, the method for determining the first clock signal and the second clock signal includes steps 610-630. The method for determining the first clock signal and the second clock signal provided by the embodiments of the present disclosure will be described in detail below in conjunction with FIG. 6.

Step 610: generating an initial clock signal.

Step 620: for the pixel units in the first pixel unit area, delaying a phase of the initial clock signal to generate the first clock signal.

Step 630: for the pixel units in the second pixel unit area, taking the initial clock signal as the second clock signal.

As shown in FIG. 6, for step 610, for example, an initial clock signal is generated according to the second gate drive signal. In an embodiment of the present disclosure, the initial clock signal may be generated based on the expected enable time period of the second gate drive signal. For example, as shown in FIG. 1A, the expected enable time period of the second gate drive signal determines the inflection point A2 of the second gate drive signal, so that the second gate drive signal can be determined, and the initial clock signal is determined based on the second gate drive signal. For example, the initial clock signal may be generated in the timing controller of the display panel, and the embodiments of the present disclosure are not limited to this case.

For step 620, for the pixel units in the first pixel unit area, the phase of the initial clock signal is delayed to generate the first clock signal. In the embodiment, the phase difference of the first clock signal relative to the second clock signal can be determined based on the expected enable time period of the second gate drive signal and the expected enable time period of the first gate drive signal. And then, based on the determined phase difference, the initial clock signal is delayed by a corresponding phase to generate the first clock signal.

For step 630, because the initial clock signal is determined based on the expected enable time period of the second gate drive signal (for driving the second pixel unit), and therefore, for the pixel units in the second pixel unit area, the initial clock signal is used as the second clock signal.

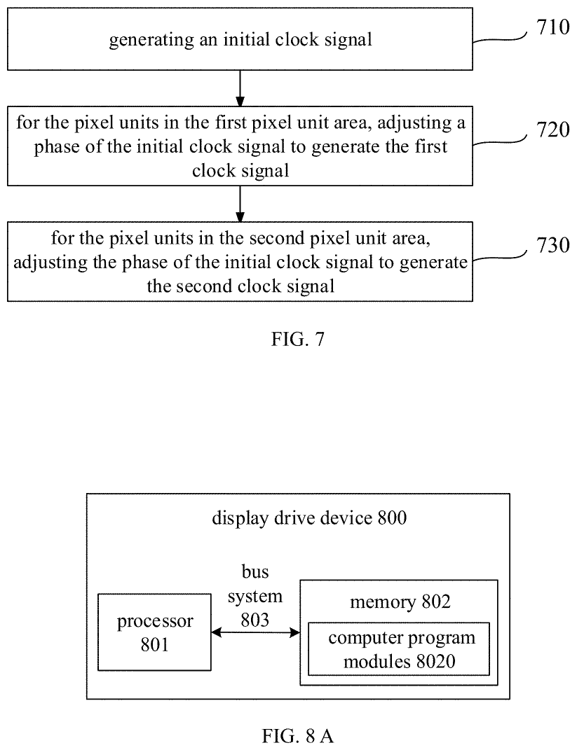

FIG. 7 shows a flowchart of a process for generating a first clock signal and a second clock signal according to still another embodiment of the present disclosure. That is, FIG. 7 is a flowchart of still another example of step 220 as shown in FIG. 2. As shown in FIG. 7, the method for determining the first clock signal and the second clock signal includes steps 710 to 730. The method for determining the first clock signal and the second clock signal provided by the embodiments of the present disclosure will be described in detail below with reference to FIG. 7.

Step S710: generating an initial clock signal.

Step S720: for the pixel units in the first pixel unit area, adjusting a phase of the initial clock signal to generate the first clock signal.

Step S730: for the pixel units in the second pixel unit area, adjusting the phase of the initial clock signal to generate the second clock signal.

As shown in FIG. 7, for step 710, for example, an initial clock signal may be generated based on a predetermined enable time period, the predetermined enable time period is different from the expected enable time period of the first gate drive signal and the expected enable time period of the second gate drive signal.

For step 720, for the pixel units in the first pixel unit area, the phase of the initial clock signal is adjusted to generate the first clock signal. For example, in the embodiment of the present disclosure, the phase difference of the first clock signal with respect to the initial clock signal may be determined based on the difference between the predetermined enable time period and the expected enable time period of the first gate drive signal. If the predetermined enable time period is greater than the expected enable time period of the first gate drive signal, the phase difference is positive, the initial clock signal is delayed by a corresponding phase to generate the first clock signal. If the predetermined enable time period is less than the expected enable time period of the first gate drive signal, the phase difference is negative, the initial clock signal is advanced by a corresponding phase to generate the first clock signal.

For step 730, for the pixel units in the second pixel unit area, the phase of the initial clock signal is adjusted to generate the second clock signal. For example, in some embodiments of the present disclosure, the phase difference of the second clock signal with respect to the initial time signal may be determined based on the difference between the predetermined enable time period and the expected enable time period of the second gate drive signal. If the predetermined enable time period is greater than the expected enable time period of the second gate drive signal, the phase difference is positive, the initial clock signal is delayed by a corresponding phase to generate the second clock signal. If the predetermined enable time period is less than the expected enable time period of the second gate drive signal, the phase difference is negative, the initial clock signal is advanced by a corresponding phase to generate the second clock signal.

For example, in some embodiments of the present disclosure, the first clock signal and the second clock signal may also be directly generated. In this embodiment, the first clock signal may be generated based on the expected enable time period of the first gate drive signal. The second clock signal may be generated based on the expected enable time period of the second gate drive signal.

The method for controlling the driving of the display device according to the embodiment of the present disclosure will be further described below through specific examples. In this example, it is assumed that the frequency F of the backlight drive signal is equal to 1000 Hz, the duty ratio P is equal to 30%, the resolution of the display panel is 7680×4320 (i.e., C=7680, R=4320), and the scanning frequency f of the display panel is equal to 60 Hz. Firstly, calculating the single high level period and the single low level period of the backlight drive signal, the single high level period Tg is (P/F), where (P/F)=30%÷1000=0.0003 s, and the single low level period Td is (1−P)/F, where (1−P)/F=(1−30%)÷1000=0.0007 s. Then, the charging time period for one row of pixel units of the display panel can be calculated as Tc=1/(f×R)=1÷(60×4320)=3.86×10-6 s.

Further, the amount of rows N of the pixel area of the display panel corresponding to the high level period Tg can be calculated as N=Tg/Tc=0.0003÷(3.86×10-6)=77.72. Considering that the amount of rows N should be an integer, therefore, N can be rounded to 78 or 77 rows. Assuming that the backlight drive signal starts to drive the backlight module during the high level period, in this example, because the ratio of the frequency of the backlight drive signal to the scanning frequency of the display panel is f/F, where f/F=16.67, it takes 16.67 cycles to drive the backlight module once using the backlight drive signal. In this way, there are 17 pixel unit areas in the display panel corresponding to the high level periods, and the 17 pixel unit areas serve as the first pixel unit area.

Then, the amount of rows M of the pixel area of the display panel corresponding to the low level period Tg can be calculated as M=Td/Tc=0.0007÷(3.86×10-6)=181.34. Considering that the amount of rows M should be an integer, therefore, M can be rounded to 181 rows. Because 16.67 cycles are required to drive the backlight module once using the backlight drive signal, there are 17 pixel unit areas in the display panel corresponding to the low level periods, and the 17 pixel unit areas serve as the second pixel unit area. The above-mentioned 17 pixel unit areas corresponding to the high level periods and the above-mentioned 17 pixel unit areas corresponding to the low level periods alternately appear.

Then, for the first pixel unit area and the second pixel unit area, a first clock signal and a second clock signal are generated, respectively. In this example, it is assumed that the expected enable time period of the first gate drive signal is 1.0 μs, and the expected enable time period of the second gate drive signal is 2.0 μs. The specific generation process of the first clock signal and the second clock signal is similar to the process described with reference to FIG. 5, FIG. 6 and FIG. 7, and will not be repeated here.

That is, the above-mentioned 17 first pixel unit areas corresponding to the high level periods are driven by the first gate drive signals generated based on the first clock signal, the above-mentioned 17 second pixel unit areas corresponding to the low level periods are driven by the second gate drive signals generated based on the second clock signal, the phase relationship between the first clock signal and the second clock signal can be generated with reference to the generation method provided in any one of the embodiments of FIGS. 5, 6, and 7, so that the first pixel unit area corresponding to the high level period can extend the charging time period, the problem of insufficient charging caused by the increase of the leakage current of the transistor in the pixel unit in the first pixel unit area can be avoided, thereby avoiding the bright area and the dark area from appearing on the display panel, and thus improving the display quality of the display device.

It should be noted that the display drive method is applicable to backlight modules with different scanning directions, frequencies, and duty ratios, and the embodiments of the present disclosure are not limited thereto.

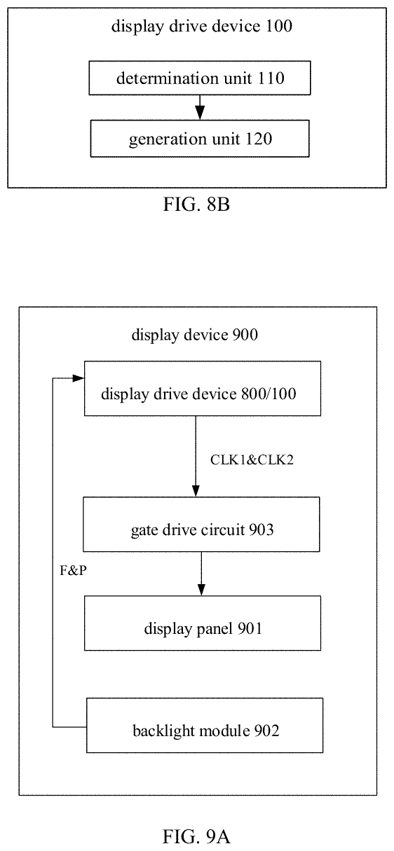

FIG. 8A is a schematic block diagram of a display drive device provided by at least one embodiment of the present disclosure. For example, as shown in FIG. 8A, the display drive device 800 includes a processor 801, a memory 802, and one or more computer program modules 8020.

For example, the processor 801 and the memory 802 are connected through a bus system 803. For example, the one or more computer program modules 8020 are stored in the memory 802. For example, the one or more computer program modules 8020 include instructions for executing the display drive method provided by any embodiment of the present disclosure. For example, instructions in the one or more computer program modules 8020 may be executed by the processor 801. For example, the bus system 803 may be a commonly used serial or parallel communication bus, etc., and the embodiments of the present disclosure are not limited to this case.

For example, the processor 801 can be a central processing unit (CPU), a digital signal processor (DSP), a graphics processing unit (GPU), or other forms of processing units with data processing capabilities and/or instruction execution capabilities, may be a general-purpose processor or a dedicated processor, and may control other components in the display drive device 800 to perform desired functions.

The memory 802 may include one or more computer program products, and the computer program products may include various forms of computer-readable storage media, such as volatile memory and/or nonvolatile memory. The volatile memory may comprise, for example, a random access memory (RAM) and/or a cache or the like. The non-volatile memory may comprise, for example, a read only memory (ROM), a hard disk, a flash memory, and the like. One or more computer program instructions may be stored on the computer-readable storage medium, and the processor 801 may execute the program instructions to implement functions (implemented by the processor 801) and/or other desired functions, for example, the display drive method, in the embodiments of the present disclosure. The computer-readable storage medium may also store various application programs and various data, such as the frequency and duty ratio of the backlight drive signal, and various data used and/or generated by the application programs.

It should be noted that, for the sake of clarity and conciseness, the embodiments of the present disclosure do not provide all the constituent units of the display drive device 800. In order to achieve the necessary functions of the display drive device 800, those skilled in the art can provide and set other unshown component units according to specific needs, and the embodiments of the present disclosure are not limited in this aspect.

FIG. 8B is a schematic block diagram of another display drive device provided by at least one embodiment of the present disclosure. For example, in the example shown in FIG. 8B, the display drive device 100 includes a determination unit 110 and a generation unit 120. For example, these units may be implemented by hardware (for example, circuit) modules or software modules, etc. The following embodiments are the same as those described herein, and similar portions will not be repeated. For example, these units can be implemented through a central processing unit (CPU), a graphics processing unit (GPU), a tensor processor (TPU), a field programmable gate array (FPGA), or other forms of processing units with data processing capabilities and/or instruction execution capabilities and corresponding computer instructions.

For example, the determination unit 110 is configured to determine a first pixel unit area corresponding to a light-emitting area of the backlight module and a second pixel unit area corresponding to a non-light-emitting area of the backlight module in the display panel. For example, the determination unit 110 can implement step 210, for the specific implementation method of the determination unit 110, reference may be made to the related description of step 210, and similar portions will not be repeated here.

The generation unit 120 is configured to respectively generate a first clock signal and a second clock signal for the first pixel unit area and the second pixel unit area. For example, the first clock signal is used for generating gate drive signals for pixel units in the first pixel unit area, the second clock signal is used for generating gate drive signals for pixel units in the second pixel unit area, and a phase of the first clock signal lags behind a phase of the second clock signal. For example, the generation unit 120 can implement step 220, for the specific implementation method of the generation unit 120, reference may be made to the related description of step 220, and similar portions will not be repeated here.

For example, the generation unit 120 can be implemented as a timing controller.

For example, in some examples, the determination unit 110 is further configured to: acquire a backlight drive signal for driving the backlight module, and determine the light-emitting area and the non-light-emitting area of the backlight module according to the backlight drive signal; an area driven during the active level period of the backlight drive signal corresponds to the light-emitting area of the backlight module, and an area driven during the inactive level period of the backlight drive signal corresponds to the non-light-emitting area of the backlight module.

For example, in other examples, the determination unit 110 is further configured to: acquire a frequency and a duty ratio of the backlight drive signal; calculate an active level period and an inactive level period in a single cycle of the backlight drive signal based on the frequency and the duty ratio; determine a charging time period for one row of pixel units of the display panel; based on the active level period and the charging time period, determine the first pixel unit area in the display panel corresponding to the active level period; and based on the inactive level period and the charging time period, determine the second pixel unit area in the display panel corresponding to the inactive level period. For example, the determination unit 110 of this example can implement steps 310-350 as shown in FIG. 3, and the specific implementation method of the determination unit 110 can refer to related descriptions of steps 510-530 and will not be repeated here.

For example, in other examples, the determination unit 110 is further configured to: acquire resolution and a scanning frequency of the display panel; and calculate the charging time period according to the resolution and the scanning frequency. For example, the determination unit 110 of this example can implement steps 410-420 as shown in FIG. 4, and the specific implementation method of the determination unit 110 can refer to related descriptions of steps 410-420 and will not be repeated here.

For example, in some examples, the generation unit 120 is further configured to: generate an initial clock signal; for the pixel units in the first pixel unit area, take the initial clock signal as the first clock signal; and for the pixel units in the second pixel unit area, advance a phase of the initial clock signal to generate the second clock signal. For example, the generation unit 120 of this example can implement steps 510-530 as shown in FIG. 5, and the specific implementation method of the generation unit 120 can refer to related descriptions of steps 510-530 and will not be repeated here.

For example, in other examples, the generation unit 120 is further configured to: generate an initial clock signal; for the pixel units in the first pixel unit area, delay a phase of the initial clock signal to generate the first clock signal; and for the pixel units in the second pixel unit area, take the initial clock signal as the second clock signal. For example, the generation unit 120 of this example can implement steps 610-630 as shown in FIG. 6, and the specific implementation method of the generation unit 120 can refer to related descriptions of steps 610-630 and will not be repeated here.

For example, in other examples, the generation unit 120 is further configured to: generate an initial clock signal; for the pixel units in the first pixel unit area, delay a phase of the initial clock signal to generate the first clock signal; and for the pixel units in the second pixel unit area, advance the phase of the initial clock signal to generate the second clock signal. For example, the generation unit 120 of this example can implement steps 710-730 as shown in FIG. 7, and the specific implementation method of the generation unit 120 can refer to related descriptions of steps 710-730 and will not be repeated here.

It should be noted that in the embodiments of the present disclosure, the display drive device 100 may include more or less circuits or units, and the connection relationship between the various circuits or units is not limited, and can be determined according to actual needs. The specific configuration of each circuit is not limited, and may be composed of analog devices according to the circuit principle, or may be composed of digital chips, or may be configured in other suitable ways.

Regarding the technical effects of the display drive device 100 and the display drive device 800 in different embodiments, reference may be made to the technical effects of the display drive method provided in the embodiments of the present disclosure, which will not be repeated here.

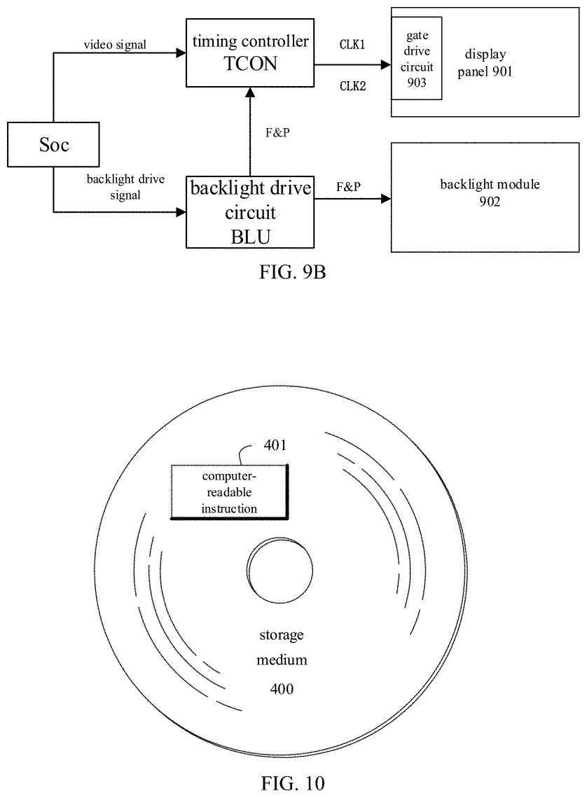

FIG. 9A shows a schematic diagram of a display device according to an embodiment of the present disclosure. As shown in FIG. 9A, the display device 900 may include a display panel 901, a backlight module 902, and a display drive device provided by any embodiment of the present disclosure, for example, the display drive device 800/100 shown in FIG. 8A or FIG. 8B. For example, the display drive device includes a timing controller for generating the first clock signal CLK1 and the second clock signal CLK2.

For example, the backlight module 902 is configured to provide backlight to the display panel 901.

For example, in some examples, the display panel 901 further includes a display substrate (not shown in the figure) and a gate drive circuit 903 prepared on the display substrate, for example, the gate drive circuit 903 is manufactured in a peripheral area of the display substrate, and a display area of the display substrate includes pixel units arranged in an array. For example, the gate drive circuit 903 is configured to output the first gate drive signal to the first pixel unit area of the display panel 901 under control of the first clock signal CLK1, and output the second gate drive to the second pixel unit area of the display panel 901 under control of the second clock signal CLK2.

The display device 900 provided by the embodiment of the present disclosure can be used in any product or component with a display function. Products or components with the display function include, but are not limited to: display panels, wearable devices, mobile phones, tablet computers, televisions, notebook computers, digital photo frames, navigators, etc.

FIG. 9B is a system schematic diagram of another display device provided by at least one embodiment of the present disclosure. For example, as shown in FIG. 9B, in the embodiment of the present disclosure, a system control board Soc provides a video signal to the timing controller, and provides a backlight drive signal to the backlight drive circuit BLU. The backlight drive circuit BLU decodes the frequency F and duty ratio P of the backlight drive signal (i.e., PWM square wave signal), on one hand, the backlight module 902 is driven based on the frequency F and the duty ratio P of the backlight drive signal, and on the other hand, the frequency F and the duty ratio P of the PWM square wave signal are fed back to the timing controller Tcon of the display device, the timing controller Tcon dynamically controls the output of the clock signal (that is, the first clock signal CLK1 and the second clock signal CLK2) according to the frequency F and the duty ratio P of the PWM square wave signal, thereby dynamically controlling the output of the gate drive signal (i.e., the first gate drive signal corresponding to the first clock signal CLK1 and the second gate drive signal corresponding to the second clock signal CLK2) of the gate drive circuit, that is, the enable time period GOE of the display panel is dynamically adjusted to implement that the pixels, which are in the area (i.e. the first pixel unit area) corresponding to the high level period of the backlight drive signal, of the display panel are charged in advance, thereby solving the problem of insufficient charging in this area and eliminating the water ripple.

At least one embodiment of the present disclosure also provides a storage medium. FIG. 10 is a schematic diagram of a storage medium provided by at least one embodiment of the present disclosure. For example, as shown in FIG. 10, the storage medium 400 non-transitory stores computer-readable instructions 401. When the non-transitory computer-readable instructions are executed by a computer (including a processor), the display drive method provided in any embodiment of the present disclosure can be executed.

For example, the storage medium may be any combination of one or more computer-readable storage media. For example, a computer-readable storage medium includes computer-readable program codes for determining the first pixel unit area and the second pixel unit area in the display panel, and another computer-readable storage medium includes computer-readable program codes for generating a first clock signal and a second clock signal for the first pixel unit area and the second pixel unit area, respectively. For example, in a case where the program codes are read by a computer, the computer can execute the program codes stored in the computer storage medium to execute, for example, the display drive method provided in any embodiment of the present disclosure.

For example, the storage medium may include a memory card of a smart phone, a storage component of a tablet computer, a hard disk of a personal computer, a random access memory (RAM), a read only memory (ROM), an erasable programmable read only memory (EPROM), a portable compact disk read-only memory (CD-ROM), a flash memory, or any combination of the above storage media, and may also be other suitable storage media.

The following should be noted:

(1) Only the structures involved in the embodiments of the present disclosure are illustrated in the drawings of the embodiments of the present disclosure, and other structures can refer to usual designs.

(2) The embodiments and features in the embodiments of the present disclosure may be combined in case of no conflict to acquire new embodiments.

What have been described above merely are exemplary embodiments of the disclosure, and not intended to define the scope of the disclosure, and the scope of the disclosure is determined by the appended claims.

1. A display drive method of a display device, wherein the display device comprises a display panel and a backlight module configured to provide backlight to the display panel, the display drive method comprises:
determining a first pixel unit area corresponding to a light-emitting area of the backlight module and a second pixel unit area corresponding to a non-light-emitting area of the backlight module in the display panel; and
for the first pixel unit area and the second pixel unit area, respectively generating a first clock signal and a second clock signal, wherein the first clock signal is used for generating gate drive signals for pixel units in the first pixel unit area, and the second clock signal is used for generating gate drive signals for pixel units in the second pixel unit area;
wherein a phase of the first clock signal lags behind a phase of the second clock signal.

2. The display drive method according to claim 1, wherein determining the first pixel unit area corresponding to the light-emitting area of the backlight module and the second pixel unit area corresponding to the non-light-emitting area of the backlight module in the display panel, comprises:
acquiring parameters of a backlight drive signal for driving the backlight module, and determining the light-emitting area and the non-light-emitting area of the backlight module according to the parameters of the backlight drive signal,
wherein the parameters of the backlight drive signal comprise an active level period and an inactive level period of the backlight drive signal, an area driven during the active level period of the backlight drive signal corresponds to the light-emitting area of the backlight module, and an area driven during the inactive level period of the backlight drive signal corresponds to the non-light-emitting area of the backlight module.

3. The display drive method according to claim 1, wherein for the first pixel unit area and the second pixel unit area, respectively generating the first clock signal and the second clock signal, comprises:
generating an initial clock signal;
for the pixel units in the first pixel unit area, taking the initial clock signal as the first clock signal; and
for the pixel units in the second pixel unit area, advancing a phase of the initial clock signal to generate the second clock signal.

4. The display drive method according to claim 1, wherein for the first pixel unit area and the second pixel unit area, respectively generating the first clock signal and the second clock signal, comprises:
generating an initial clock signal;
for the pixel units in the first pixel unit area, delaying a phase of the initial clock signal to generate the first clock signal; and
for the pixel units in the second pixel unit area, taking the initial clock signal as the second clock signal.

5. The display drive method according to claim 1, wherein for the first pixel unit area and the second pixel unit area, respectively generating the first clock signal and the second clock signal, comprises:
generating an initial clock signal;
for the pixel units in the first pixel unit area, adjusting a phase of the initial clock signal to generate the first clock signal; and
for the pixel units in the second pixel unit area, adjusting the phase of the initial clock signal to generate the second clock signal.

6. The display drive method according to claim 2, wherein determining the first pixel unit area corresponding to the light-emitting area of the backlight module and the second pixel unit area corresponding to the non-light-emitting area of the backlight module in the display panel according to the backlight drive signal for driving the backlight module, comprises:
acquiring a frequency and a duty ratio of the backlight drive signal;
calculating an active level period and an inactive level period in a single cycle of the backlight drive signal based on the frequency and the duty ratio;
determining a charging time period for one row of pixel units of the display panel;
based on the active level period and the charging time period, determining the first pixel unit area in the display panel corresponding to the active level period; and
based on the inactive level period and the charging time period, determining the second pixel unit area in the display panel corresponding to the inactive level period.

7. The display drive method according to claim 6, wherein determining the charging time period for one row of pixel units of the display panel, comprises:
acquiring resolution and a scanning frequency of the display panel; and
calculating the charging time period according to the resolution and the scanning frequency.

8. The display drive method according to claim 2, wherein the backlight drive signal is a pulse width modulation signal.

9. A display drive device of a display device, comprising:
a processor;
a memory; and
one or more computer program modules, wherein the one or more computer program modules are stored in the memory and are configured to be executed by the processor, and the one or more computer program modules comprise instructions for implementing the display drive method according to claim 1.

10. A display drive device of a display device, wherein the display device comprises a display panel and a backlight module configured to provide backlight to the display panel, and the display drive device comprises:
a determination unit, configured to determine a first pixel unit area corresponding to a light-emitting area of the backlight module and a second pixel unit area corresponding to a non-light-emitting area of the backlight module in the display panel; and
a generation unit, configured to respectively generate a first clock signal and a second clock signal for the first pixel unit area and the second pixel unit area, wherein the first clock signal is used for generating gate drive signals for pixel units in the first pixel unit area, and the second clock signal is used for generating gate drive signals for pixel units in the second pixel unit area;
wherein a phase of the first clock signal lags behind a phase of the second clock signal.

11. The display drive device according to claim 10, wherein the determination unit is further configured to:
acquire parameters of a backlight drive signal for driving the backlight module, and determine the light-emitting area and the non-light-emitting area of the backlight module according to the parameters of the backlight drive signal,
wherein the parameters of the backlight drive signal comprise an active level period and an inactive level period of the backlight drive signal, an area driven during the active level period of the backlight drive signal corresponds to the light-emitting area of the backlight module, and an area driven during the inactive level period of the backlight drive signal corresponds to the non-light-emitting area of the backlight module.

12. The display drive device according to claim 10, wherein the generation unit is further configured to:
generate an initial clock signal;
for the pixel units in the first pixel unit area, take the initial clock signal as the first clock signal; and
for the pixel units in the second pixel unit area, advance a phase of the initial clock signal to generate the second clock signal.

13. The display drive device according to claim 10, wherein the generation unit is further configured to:
generate an initial clock signal;
for the pixel units in the first pixel unit area, delay a phase of the initial clock signal to generate the first clock signal; and
for the pixel units in the second pixel unit area, take the initial clock signal as the second clock signal.

14. The display drive device according to claim 10, wherein the generation unit is further configured to:
generate an initial clock signal;
for the pixel units in the first pixel unit area, delay a phase of the initial clock signal to generate the first clock signal; and
for the pixel units in the second pixel unit area, advance the phase of the initial clock signal to generate the second clock signal.

15. The display drive device according to claim 11, wherein the determination unit is further configured to:
acquire a frequency and a duty ratio of the backlight drive signal;
calculate an active level period and an inactive level period in a single cycle of the backlight drive signal based on the frequency and the duty ratio;
determine a charging time period for one row of pixel units of the display panel;
based on the active level period and the charging time period, determine the first pixel unit area in the display panel corresponding to the active level period; and
based on the inactive level period and the charging time period, determine the second pixel unit area in the display panel corresponding to the inactive level period.

16. The display drive device according to claim 15, wherein the determination unit is further configured to:
acquire resolution and a scanning frequency of the display panel; and
calculate the charging time period according to the resolution and the scanning frequency.

17. The display drive device according to claim 11, wherein the backlight drive signal of the backlight module is a pulse width modulation signal.

18. A display device, comprising: a display panel, a backlight module, and the display drive device according to claim 9,
wherein the backlight module is configured to provide the backlight to the display panel.

19. The display device according to claim 18, wherein the display panel comprises a display substrate and a gate drive circuit prepared on the display substrate,
wherein the gate drive circuit is configured to output a first gate drive signal to the first pixel unit area under control of the first clock signal, and to output a second gate drive signal to the second pixel unit area under control of the second clock signal.

20. A storage medium, non-temporarily storing computer-readable instructions, wherein in a case where the computer-readable instructions are executed by a computer, the display drive method according to claim 1 can be executed.
